(19) United States
(12) Patent Application Publication
(10) Pub. No.: US 2024/0334897 A1
(43) Pub. Date: Oct. 10, 2024

(54) METHOD FOR PET WASTE REMOVAL

(71) Applicant: BRILLIANT PET 2 LLC, Chicago, IL (US)

(72) Inventors: Alan J. COOK, Chicago, IL (US); Thomas E. DEVLIN, Winchester, MA (US); Kris W. GRUBE, Bloomington, IN (US)

(21) Appl. No.: 18/746,359

(22) Filed: Jun. 18, 2024

Related U.S. Application Data
(63) Continuation of application No. 16/513,000, filed on Jul. 16, 2019, now Pat. No. 12,010,974.
Application No. 16/513,000 is a continuation-in-part of application No. 16/210,938, filed on Dec. 5, 2018, now Pat. No. 11,895,981.
Application No. 16/210,938 is a continuation-in-part of application No. 15/344,209, filed on Nov. 4, 2016.
Application No. 16/210,938 is a continuation of application No. 15/344,209, filed on Nov. 4, 2016.
(60) Provisional application No. 62/351,792, filed on Jun. 17, 2016.
(60) Provisional application No. 62/345,500, filed on Jun. 3, 2016.
(60) Provisional application No. 62/250,615, filed on Nov. 4, 2015.

(51) Int. Cl. A01K 1/01

(52) U.S. Cl. CPC A01K 1/0117

(57) ABSTRACT

A method for pet waste removal. The method includes installing a pad on a surface of a platform and receiving pet waste on the pad. A portion of the pad receiving the pet waste defines a soiled portion of the pad. The method includes capturing one or more images of the pad. The one or more captured images are compared to a reference image. Based on the one or more captured images being compared to the reference image, a type of pet waste is detected on the pad on the soiled portion of the pad or an amount of pet waste is detected on the soiled portion of the pad.

### CROSS-REFERENCE TO RELATED APPLICATIONS

The present invention is a continuation of U.S. application Ser. No. 16/513,000 filed on Jul. 16, 2019. U.S. application Ser. No. 16/513,000 is a contin-uation-in-part of U.S. application Ser. No. 16/210,938 filed on Dec. 5, 2018, now U.S. Pat. No. 11,895,981 issued on Feb. 13, 2024. U.S. application Ser. No. 16/513,000 is a continuation-in-part of U.S. application Ser. No. 15/344,209 filed on Nov. 4, 2016. U.S. application Ser. No. 16/210,938 is a continuation of U.S. Ser. No. 15/344,209 filed on Jun. 17, 2016. U.S. Pat. No. 15,344,209 claims benefit of priority from provisional applications U.S. Application Ser. No. 62/351,792 filed on Jun. 17, 2016, U.S. Application Ser. No. 62/345,500 filed on Jun. 3, 2016, and U.S. Application Ser. No. 62/250,615 filed on Nov. 4, 2015. Every application, publication, and patent listed in this paragraph are hereby incorporated by reference in their entireties.

### BACKGROUND

### Technical Field

The present invention relates to a removable pet waste cartridge used in combination with a pet waste machine system and, in particular, to a generally removable and disposable pet waste cartridge that disposes of both the waste and the waste's odor that are contained within a generally sealed waste pad when the pad is rolled up in its finished state for removal from the waste machine.

### Description of Related Art

There are millions of pet dogs in the United States and the rest of North America. Many dog owners even have more than one dog within their residence in Urban and Rural North America. The dogs excrete a large amount of both liquid and solid waste each day of the year. Due to the busy commitments and work schedules of pet owners, the dogs are left in the residence unattended for hours or days at a time, to accommodate work and event schedules of the pet owners. Dogs are known to urinate several times a day and excrete solid wastes at least once daily too. Dog owners want to keep their residences clean and without the attendant odor accompanying either urination or solid waste excrement. Pet owners are also known to teach their dogs or pets to eliminate their bodily waste on paper within their residences or condition their pets to eliminate their waste outdoors when the pet owner takes the pet for a walk outdoors. Many municipalities have adopted “pooper scooper” laws for sanitary reasons, that means pet owners are picking up nasty solid waste on their walks with the pet outdoors.

Outdoor elimination of pet waste can become problematic if extreme weather conditions are found by pet owners in the time allotted to the daily walk of their pet. If the weather is nasty, the walk often gets postponed or delayed, which stresses out the pet. Therefore, housebreaking pads are used by tens of thousands of home owners with their puppies and dogs around the country. Dog owners, especially in large cities where dog parks and available yards are at a minimum, generally pre-fer to “paper” train their pets. Because of work schedules, some owners may not get home to walk the dog on time, so they “paper” train the pet to use the pads to prevent the dog from eliminating indiscriminately in the house or apartment. Many apartment dwelling dogs, especially among the smaller breeds, are “paper” trained exclu-sively. Whether used for housebreaking puppies or for “paper” training indoor dogs who will use these pads throughout their lifetime, housebreaking pads are one of the larger expenditures for dog owners.

U.S. Pat. No. 8,464,662 describes an apparatus that maintains housebreaking pads for a pet owner, by automatically removing and sealing soiled pads and waste and replacing the soiled pad with a clean pad. The apparatus senses when a pet is using a housebreaking pad, and when the pet is finished, removes and seals the pad and the waste automatically, moving the pad into a repository for later disposal and replacing the soiled pad with a clean pad. The apparatus seals the waste and pad with plastic film having low vapor permeability for disposal on a once-daily or less frequent basis. The apparatus minimizes or eliminates odors associated with canine elimination by removing the pads immediately after elimination is completed, and sealing the waste. A control unit, triggered by a sensor, has a single cycle or a multiple cycle operation, operating a motor that rolls the soiled composite pad onto an arbor in the repository.

Another major problem that plagues pet owners is the annoyance of replacing soiled pads. Offensive odors from the soiled pads may permeate the household. Owners need to flush the feces down a toilet or place the feces in a sealed container to decrease the odor. Dogs, especially puppies, when stressed sometimes develop the undesirable habit of eating their own feces. If the dog develops the habit, the dog owner needs to pick up fecal matter quickly to break the habit. Disposing of the fecal matter and the pads is not only a continual annoyance, but also causes dog owners to bend down multiple times a day, often bothering the lower back and stressing the knees. There is also the possibility that the pet owner will end up with urination or fecal matter on their hands, clothing or other residential items when disposing of open faced pads or paper haphazardly rolled up to contain the pet waste. This is especially burdensome to the elderly, physically handicapped, and blind who have com-panion, assistance, or guide dogs. The handling of pet waste may also affect the over-all health of the elderly person who comes in contact with fecal or urination on their hands and clothing and due to poor eyesight or numbness in their fingers does not realize that the pet waste is still on their hands.

### BRIEF SUMMARY

This summary provides a discussion of aspects of certain embodiments of the invention. It is not intended to limit the claimed invention or any of the terms in the claims. The summary provides some aspects but there are aspects and embodiments of the invention that are not discussed here.

In one aspect, a method for pet waste removal is provided. The method includes installing a pad on a surface of a platform and receiving pet waste on the pad. A portion of the pad receiving the pet waste defines a soiled portion of the pad. The method includes capturing one or more images of the pad. The one or more captured images are compared to a reference image. Based on the one or more captured images being compared to the reference image, a type of pet waste is detected on the pad on the soiled portion of the pad or an amount of pet waste is detected on the soiled portion of the pad.

In one embodiment, a type of pet waste is detected, and the type of pet waste includes a solid waste, a liquid waste, or a combination thereof. The method can also include, after detecting the type of pet waste, differentiating the types pet waste between solid waste and liquid waste.

In another embodiment, the method can include advancing pad across the platform until at least one of the one or more captured images matches the reference image. Advancing the pad can include receiving a command from a remote control, wherein the remote control is in communication with the platform via an internet connection. The method can also include generating a notification for display on the remote device indicating when to dispose of the pad or when to position a fresh pad on the platform. The remote control can be a Bluetooth device, a home automation system, a mobile user terminal, or an Internet connected device.

Additionally, or alternatively, the method can include generating a notification for display on the remote device warning an end user to reposition the pad to track properly along the platform. Additionally, or alternatively, the method can include checking for a presence of an animal on platform with an animal sensor. Checking for the presence of an animal can include comparing a captured image with the reference image. Advancing the pad can be delayed if the presence of the animal is detected by the animal sensor. Advancing the roll of pads can be performed automatically with a control and drive module, wherein the control and drive module is coupled to the platform and capable of advancing the pad across the platform.

In yet another embodiment, the pad can include a plurality of markings along a length of the pad. The method can also include, after capturing one or more images of the pad disposed on the platform, reading at least one of the plurality of markings with a mark sensor to determine a position of the soiled portion of the pad.

In another embodiment, the method can include, after capturing the one or more images, determining a cleanliness of the pad.

In yet another embodiment, the reference image can be a clean image.

In another aspect, a method for pet waste removal is provided. The method includes installing a pad on a surface of a platform and receiving pet waste on the pad. A portion of the pad receiving the pet waste defines a soiled portion of the pad. The method includes capturing one or more images of the pad. The one or more captured images are compared to a reference image. The method can also include, based on the one or more captured images being compared to the reference image, detecting a type of pet waste on the pad, wherein the type of pet waste comprises a solid waste, a liquid waste, or a combination thereof. The method can also include based on the one or more captured images being compared to the reference image, detecting an amount of pet waste on the soiled portion of the pad.

In one embodiment, the method can include, differentiating the pet waste. Additionally, the method can include advancing the pad until at least one of the one or more captured images matches the reference image. Advancing the pad can include receiving a command from a remote control. The remote control can be in communication with the platform via an internet connection. The remote control can be a Bluetooth device, a home automation system, a mobile user terminal, or an Internet connected device.

Additionally, or alternatively, the pad can include a plurality of markings along a length of the pad, and the method can include, after capturing one or more images of the pad, reading at least one of the plurality of markings with a mark sensor to determine the position of the soiled portion of the pad. Additionally, or alternatively, the method can include checking for a presence of an animal on the platform with an animal sensor. Checking for the presence of an animal can include comparing a captured image with the reference image, and advancing the pad can be delayed if the presence of the animal is detected by the animal sensor.

Additionally, or alternatively, the method can include determining a cleanliness of the pad.

### BRIEF DESCRIPTION OF THE DRAWINGS

Embodiments of the present disclosure are described by way of following drawings pointing out the various details to the inventive automatic or manual pad roll system. The main features and advantages of the present disclosure will be better understood with the following descriptions, claims, and drawings, where:

FIG. 1 is a diagrammatic perspective view of the invention demonstrating a pet eliminating on a roll of waste pads.

FIG. 2 is a diagrammatic perspective view of the invention with a partial elevation cut away showing the roll of waste pads in the supply assembly stretched across the pet bed to a take-up rod in the take-up assembly which shows a repository portion of the invention.

FIG. 3 is a diagrammatic side elevation view of the invention with a partial elevation cut away showing the roll of waste pads in the supply assembly stretched across the pet bed to a take-up rod in the take-up assembly which shows a repository portion of the invention.

FIG. 4 is a diagrammatic perspective view of the invention showing the lower portion of the machine and the pet bed for receiving a pet roll of waste pads therein.

FIG. 5 is a diagrammatic perspective view of the invention showing the machine with the supply and take-up assembly covers open for receiving a pet roll of waste pads therein.

FIG. 6 is a diagrammatic perspective view of the invention demonstrating the attachment of a removable control and drive module connection to the take-up assembly.

FIG. 7 is a diagrammatic perspective view of the invention demonstrating a removable control and drive module of the invention.

FIG. 8 is a diagrammatic perspective view of the components in the waste cartridge of the invention.

FIG. 9 is a waste cartridge ready for disposal of the invention.

FIG. 10 is a diagrammatic perspective view of the waste cartridge components ready for installation into the waste machine.

FIG. 11 is a diagrammatic perspective view of the invention with a roll of waste pad being installed on a waste machine.

FIG. 12 is a diagrammatic perspective view continuation of the invention with a roil of waste pad being installed on a waste machine.

FIG. 13 is a diagrammatic perspective view of the invention showing the machine with the supply assembly receiving a pet roll of waste pads therein.

FIG. 14 is a diagrammatic perspective view of the invention showing the machine with the take-up assembly with the removal of the waste cartridge for disposal with the pet waste therein.

FIG. 15 is a diagrammatic perspective view of the invention showing the gearing and drive attachment of machine to the take-up assembly for receiving an end of pet roll of waste pads under a pair of clips at one end of the take-up rod.

FIG. 16 is a diagrammatic perspective view of the invention showing the gearing and drive attachment of the machine to the take-up assembly for receiving an end of pet roll of waste pads under a pair of clips at one end of the take-up rod and showing attachment of the one end of the pad to the clip.

FIG. 17 is a diagrammatic perspective view of the invention showing the attachment of the one end of the pad to the clip.

FIG. 18 is a diagrammatic perspective view of the invention showing the meshing of the gear on the end cap to the drive gear on the control and drive module.

FIG. 19 is a diagrammatic perspective view of the invention showing the attachment of the one end of the pad with holes to pins on the take-up rod.

FIG. 20 is a diagrammatic perspective view of the invention showing a hand crank mechanically connected to the take-up rod in the take-up assembly.

FIG. 21 is a diagrammatic perspective view of the invention showing a foot treadle mechanically connected to the take-up rod in the take-up assembly.

FIG. 22 is a diagrammatic perspective view of the invention showing a foot roll mechanically connected to the take-up rod in the take-up assembly.

FIG. 23 is a diagrammatic perspective view of the invention with the covers on the supply and take-Up assembly opened showing the installation of a waste cartridge therein.

FIG. 24 is a further diagrammatic perspective view of the invention with the covers on the supply and take-up assembly opened showing the installed waste cartridge therein.

FIG. 25 is another diagrammatic perspective view of the invention with the covers on the supply and take-up assembly opened showing the installed waste cartridge therein.

FIG. 26. is a diagrammatic perspective view of the invention with the covers on the supply and take-up assembly closed showing the installed waste cartridge and machine ready for a pet elimination.

FIG. 27 is a diagrammatic perspective view of a dog on the machine being viewed by infrared or other type of sensor according to the present invention.

FIG. 28 is a diagrammatic perspective view of a both infrared sensors on the machine according to the present invention.

FIG. 29 is a diagrammatic perspective closer view of a both infrared sensors on the machine according to the present invention.

FIG. 30 is a bottom diagrammatic perspective view of both infrared sensors on the machine according to the present invention.

FIG. 31 is a diagrammatic perspective view of a multi-ply waste paper or pad material used with the machine or apparatus according to the present invention.

### DETAILED DESCRIPTION

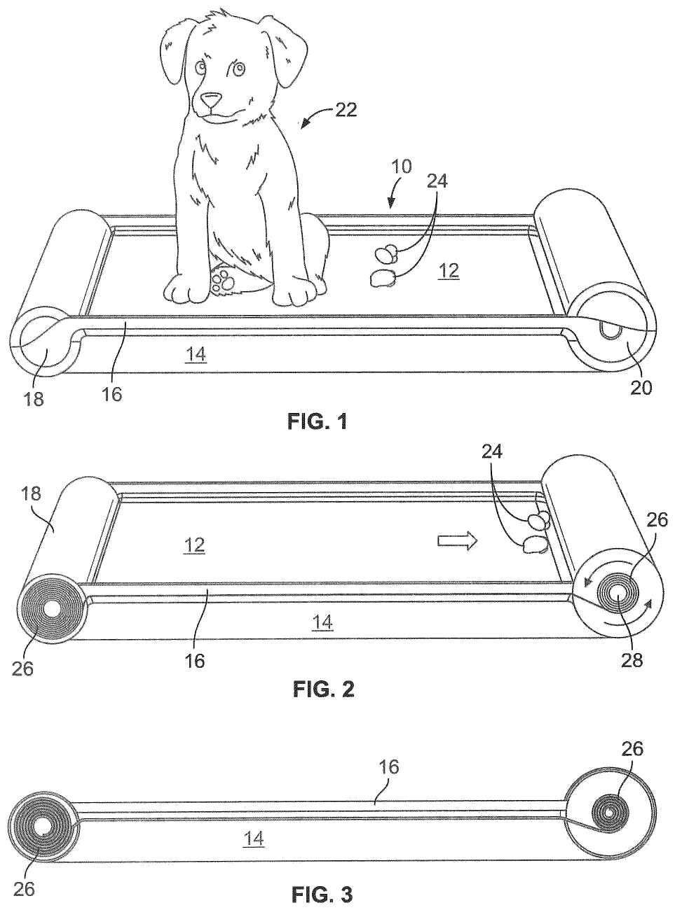

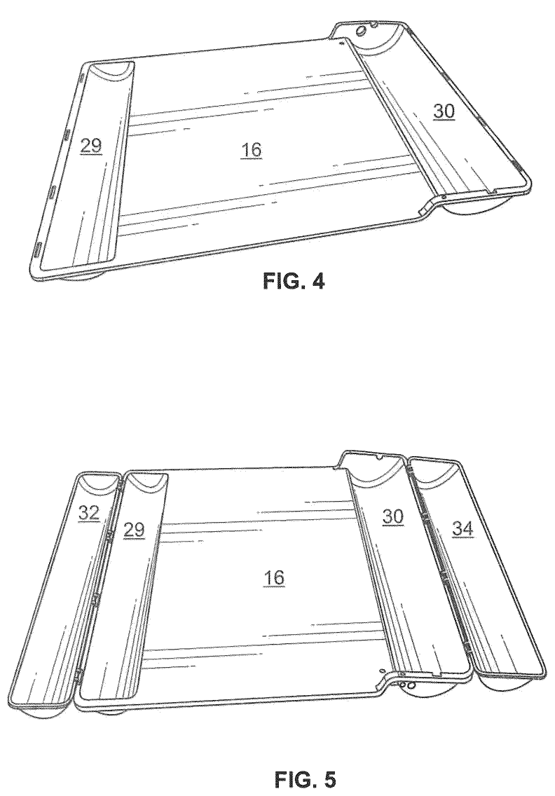

FIG. 1 illustrates an automatic or manual waste cartridge in combination with a waste machine system 10 with a waste pad 12 for later disposal with a pet 22 eliminating solid waste 24 on the pad 12. The apparatus or machine 14 detects the pet 22 eliminating solid waste 24 and when the pet 22 leaves the apparatus 14, the apparatus 14 automatically cycles to replace that portion of the soiled pad with a clean portion from the pad roll 26 by removing and sealing the soiled portion of the pad 12 in a take-up assembly 20 and feeding a clean portion of the pad roll 26 from a supply assembly 18. The apparatus is programmed to have a stage interval where the pet 22 stands on the portion of exposed pad 12 on a pet bed 16, the stage interval is followed by a repository interval as shown in FIG. 2 where the apparatus 14 removes and seals the soiled portion of the pad 12 with the solid waste 24 and any urine in the take-up assembly 20 wherein the take-up rod or core 28 rotates in a counterclockwise direction to take up and seal the soiled pad wound around the rod 28 within the take-up assembly 20 for later removal and then disposal.

The repository portion is aesthetically covered by a cylindrical half portion of the machine 14 attached to the pet bed 16 with a rotatable cover 34 in the take-up assembly 20 to hide the soiled portion 12 of the pad roll 26. The elimination stage portion for the pet 22 has the machine bed 16 connected between the supply and take-up assemblies 18 and 20, respectively, where the waste pad portion 12 therebetween is set on top of the pet bed 16. The pet 22 stands on top of the pad portion 12 on the pet bed 16 and eliminates feces 24 and urine. The supply assembly also has a rotatable cover 32 with a lower cylindrical portion 29 for receiving the pad roll 26 of a pre-determined length, width, and diameter. The pad roll 26 when housed within the supply assembly 18 has its axis below the pet bed 16. The waste pad portion can be stretched across the bed 16 to the take-up rod 28, which has its axis below the pet bed 16 to create the proper friction and tension of the pad 12 across the bed. This configuration produces an advantage of preventing jamming or hampering the take-up of the soiled portions of the pad roll 26 within the take-up assembly 20. The configuration also advantageously provides taking up the soiled pad without any part of the machine contacting the top, soiled surface of the pad. The cover 32 on the supply assembly, when closed, further provides the proper tension on the waste paper or pad portion 12 moving across the bed 16 from the supply to the take-up assemblies, respectively, as shown in FIGS. 1, 2, 3, and 26.

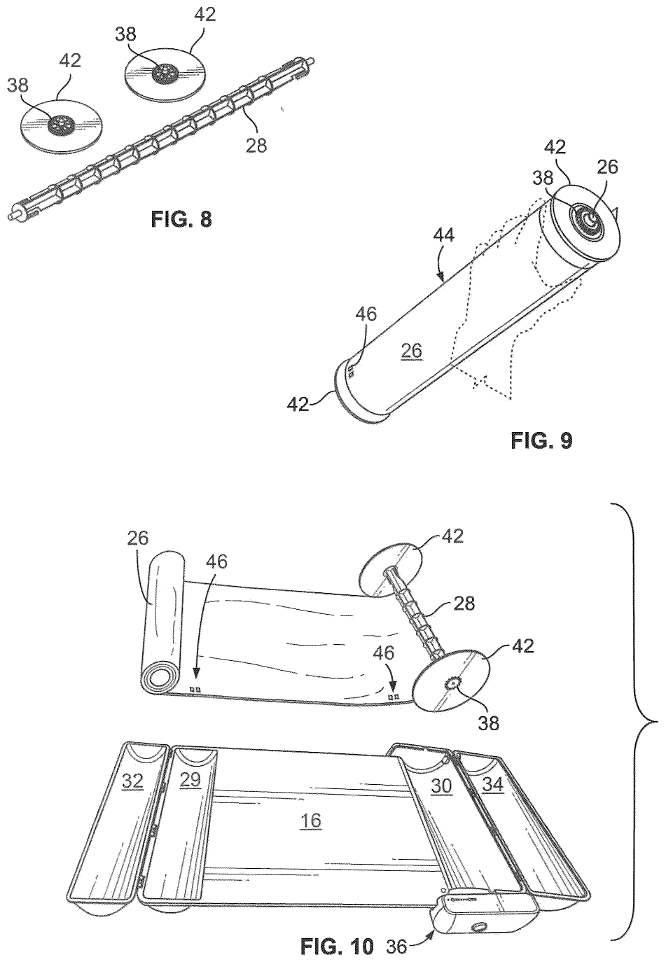

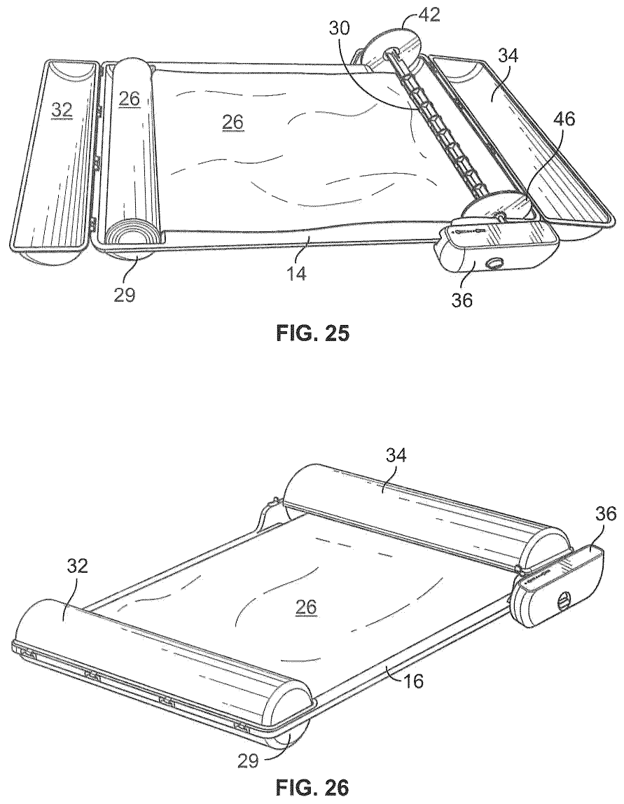

FIGS. 8-10 illustrate a waste cartridge 44 and its components as follows: a core or rod 28, a pair of end caps 42 connected by a press fit to the opposing ends of the rod 28. The end cap often includes a gear 39 to mesh with corresponding teeth on a gear 38 on the drive shaft connected to the drive with a removable control and drive module 36 that is key fitted with a pair of guide pins 40 to the side of the take-up assembly where the gear 38 extends through one side of the take-up assembly to en-gage the identical meshing teeth on the gear 39 on the end cap to rotate the take-up rod or core 28 in a counterclockwise rotation as shown in FIG. 2. The pad roll 26 is connected by holes at one end of the pad roll as shown in FIG. 19 press fitted over pins 54 on the rod 28. The one end of the pad roll 26 is capable of being fed through a slot in the rod 28 as shown in FIGS. 9 and 24 wherein the pad roll 26 is installed in the cylindrical half 29 of the supply assembly and the take-up rod 28 with the one end of the pad roll 26 inserted through a slot on the rod 28, and attendant end caps 42 are inserted into the cylindrical half base 30, whereupon the covers 32 and 34 are closed and the first portion of the fresh waste pad 12 is stretched across the bed 16 as shown in FIGS. 1, 2, 3, 25 and 26. The control and drive module 36 may be connected (via wired or wireless connection) to a remote control for remote operation. Examples of wireless connection may include WiFi, Bluetooth®, radio, IR, and cloud. The control and drive module 36 may be connected to a computer, phone, remote, or web browser.

As further shown in FIG. 9, marks 46 are on the pad border for the machine to read and provide information depending on the spacing and interval of the marks 46 thereon. Information such as the amount of the roll left for use or a fresh roll was just installed is the type of information available from these marks on the waste paper and pad roll.

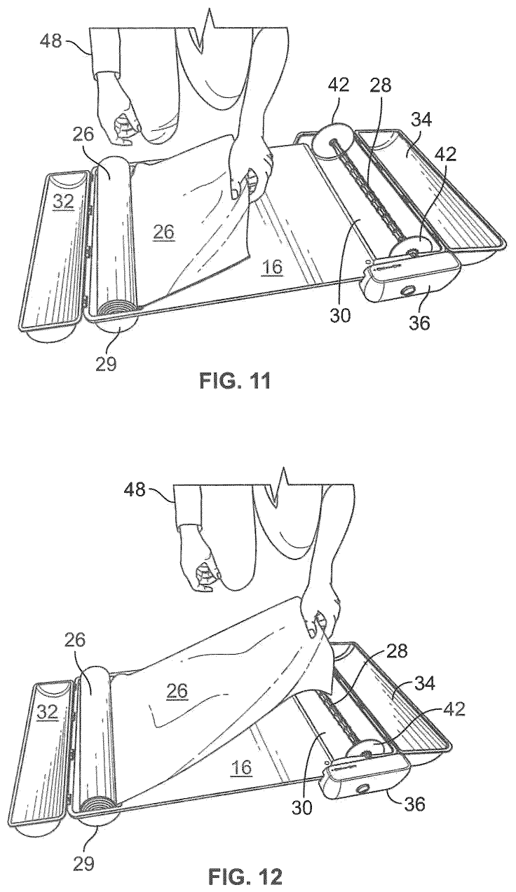

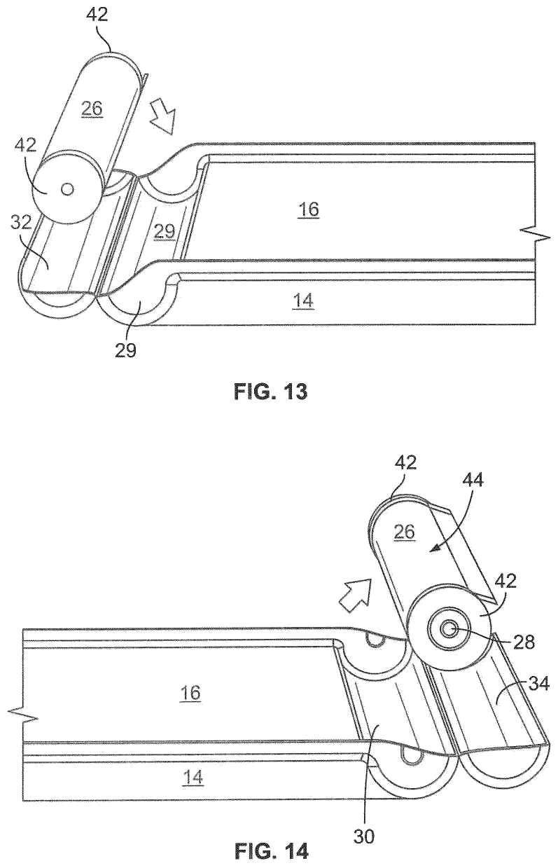

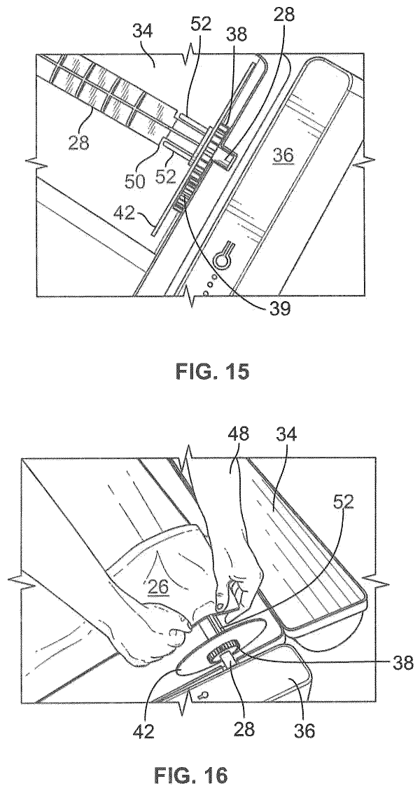

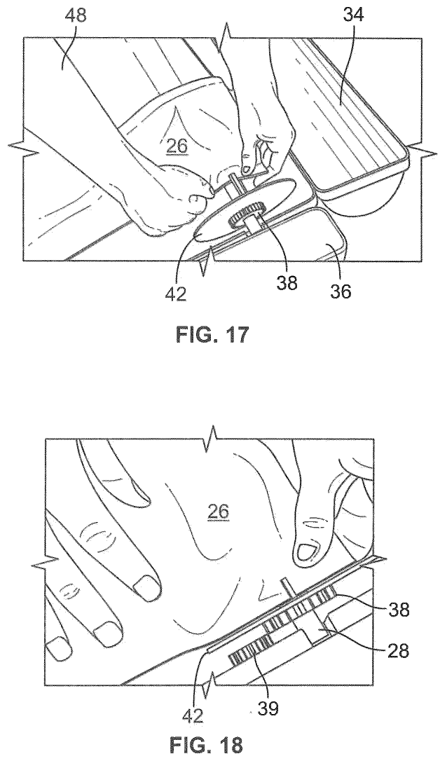

FIGS. 11-18 show the installation of the waste paper on the take-up rod 28 from stretching the waste paper 12 from the pad roll 26 across the bed 16 to the take-up rod 28 and the use of clips at one end of the take-up rod 28 wherein a right angle nib 50 provides friction against the paper when inserted underneath a pair of clips on one end of the rod 28 or under a pair of clips on opposing ends of the rod. The nib 50 with the friction engagement makes sure that the waste paper 12 does not slip off the clips on the first several counterclockwise turns of the rod within the housing of take-up assembly 20.

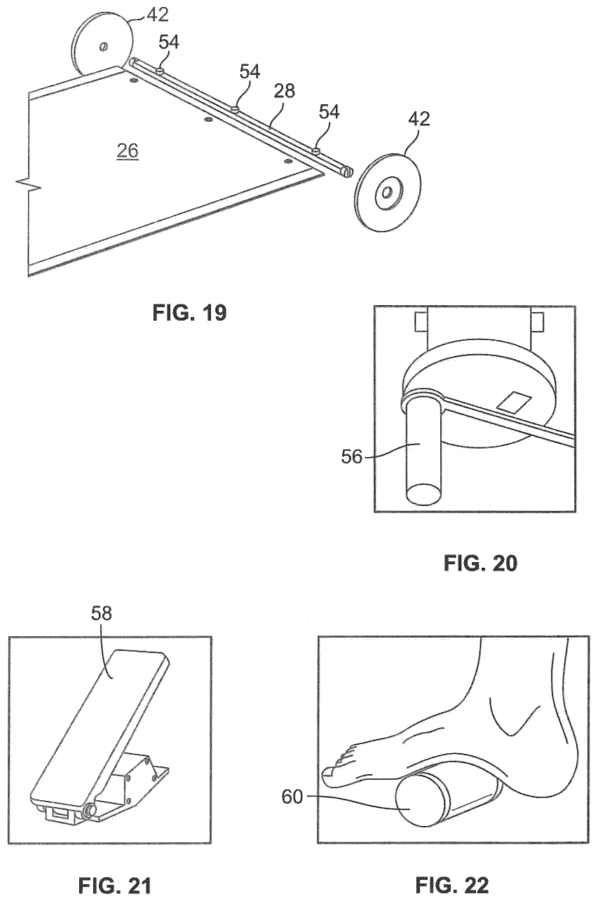

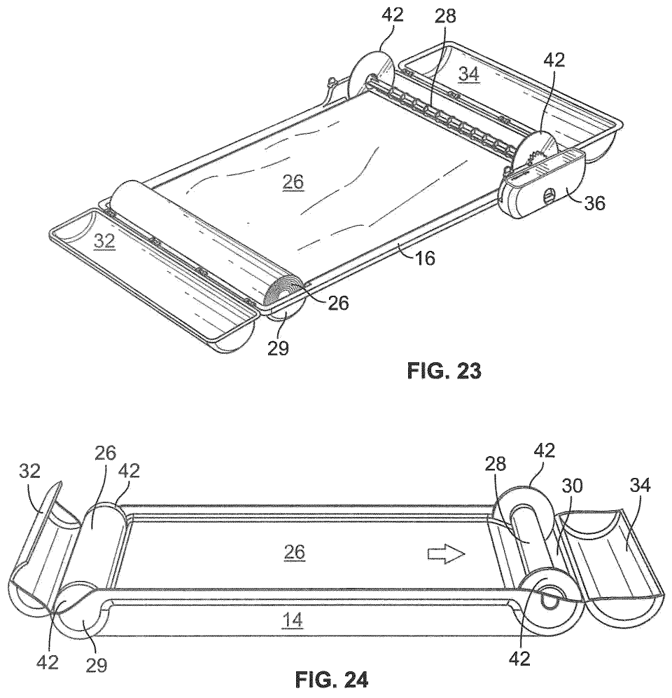

FIGS. 20-22 illustrate manual advancement of the waste paper across the bed 16 via a handle crank that is mechanically connected to the rod 28 to advance the soiled pad 12. A treadle 58 is shown in FIG. 21 which is stepped on to advance the pad. FIG. 22 shows a foot roll mechanically connected to the rod 28 to advance the pad and to take up the soiled portion of the pad on the pet bed 16 after pet 22 eliminates its waste.

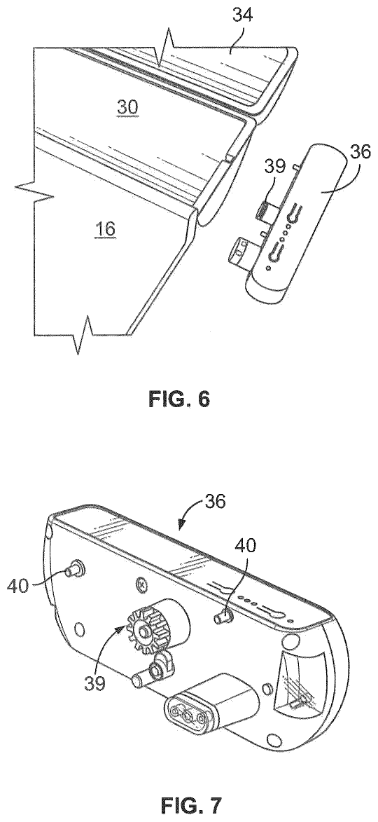

FIG. 18 shows the meshing of identical tooth gears 38 on the end cap and gear drive on the removable control and drive module 36 during installation of the take-up rod 28 in the take-up assembly 20. FIGS. 6 and 7 show the removable control and drive module 36 that is used to program the movement of the pad across the bed 16 of the machine 14. In operation, the waste cartridge with its pad roll 26 is inserted into the supply assembly 18 while its take-up rod 28 attached to one end of pad is inserted into the take-up assembly 20 with a portion of the pad 12 stretched across the pet bed 16.

Then the covers of the supply and take-up assemblies 32 and 34, respectively, are closed and the waste machine is ready to accept its first dog or other pet for the elimination of the pet's waste.

A roll of pet waste paper 26 for use with a pet waste machine 14 comprises an absorbent front side material on a roll of pet waste paper and a nonabsor-bent back side material on the roll of waste paper or waste pad. Further, the waste paper or pad includes an absorptive non-woven spun bond on a top layer for tear resistance, an absorbent polymer in a middle layer, and a plastic non-absorbent bottom layer for leak protection from the liquid and solid waste. The pet waste paper may also include an air laid paper top layer allowing the removal of other layers. The pet waste paper is capable of being configured to include either a four- or five-layer construction with the mixing of absorbent and non-absorbent or non-permeable layers. It is possible to have a single layer with absorbent and non-absorbent on opposing sides of the single layer.

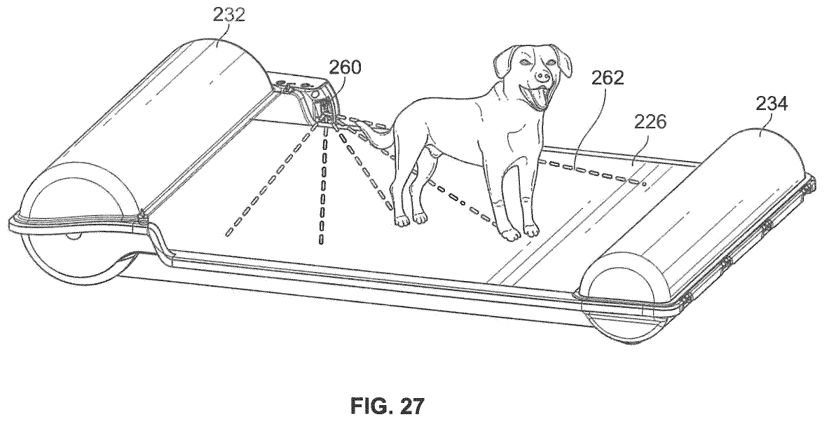

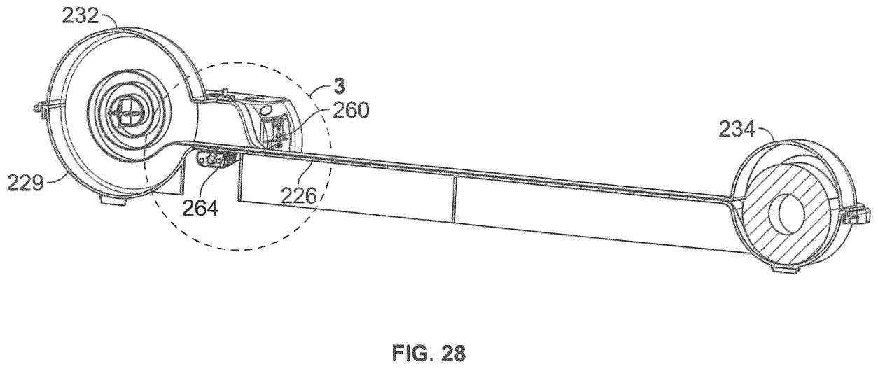

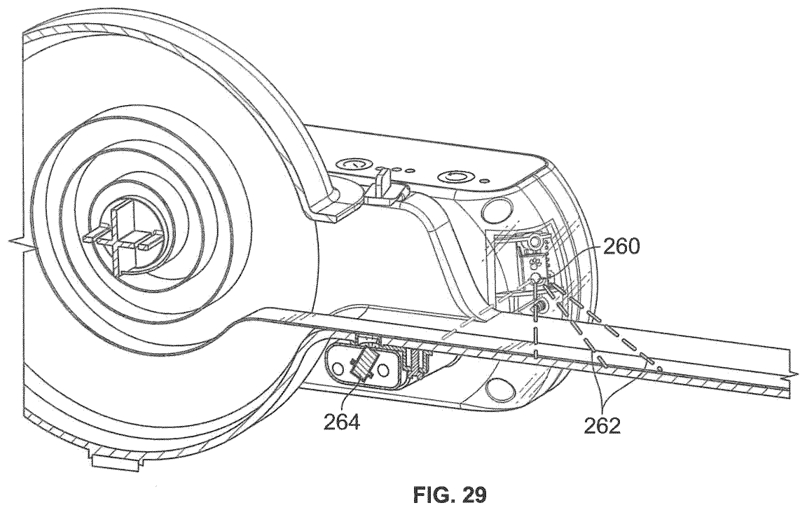

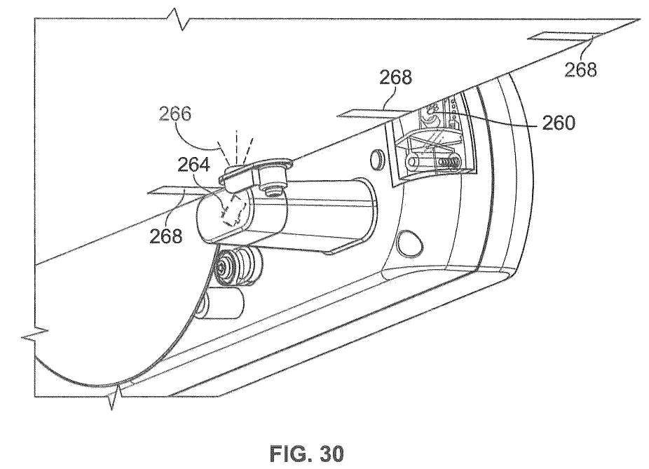

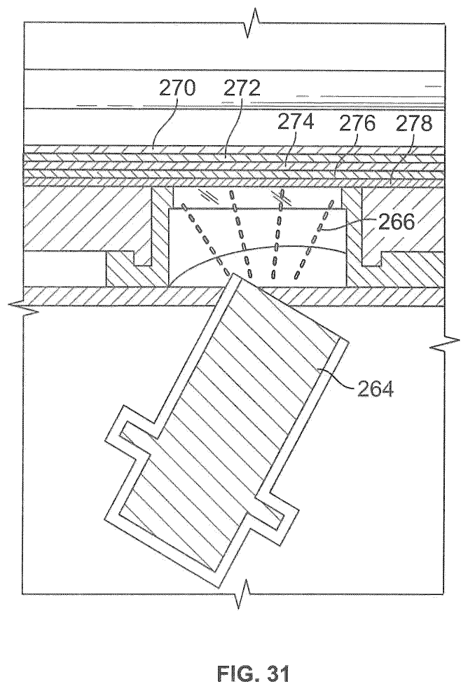

FIGS. 27-30 shows the infrared sensors on the machine or apparatus for detecting the marking on the waste paper or pads passing over the infrared sensor 264. The pet sensor beam 262 is used to detect the presence of the dog on the waste station or platform of the apparatus and if the dog is sensed, a programmed operation will not occur. The apparatus can be further configured to capture an image of the pad. In one embodiment, an image of an unused pad (or clean pad) is captured as a reference image to determine pad cleanliness. The apparatus can capture subsequent images of the pad to compare with reference images to determine a cleanliness of the pad. The apparatus can be configured to advance the pad until a subsequently captured image matches the reference image. The apparatus may further be configured to differentiate between solid waste and liquid waste in the captured images. The apparatus can be further configured to detect the presence of an animal via the comparison of the captured images. The image comparison features provide the advan-tageous benefit of allowing the apparatus to operate without requiring the user to monitor the apparatus. Additionally, the image comparison features further provide the advantage of optimizing the amount of pad usage. There is a lower infrared sensor 264 on the control module for sensing the paper markings as the paper passes from the supply housing across the waste bed to the take-up housing on the rod reel therein. The paper markings 268 help to determine the information necessary to determine paper advancement, remaining paper left on a roll of pads, and when the end of the roll of pads is about to occur.

The paper or pad is generally composed of five layers but may be as little as just one layer too. The top sheet 270 is a bonded layer to prevent dog paws from ripping the paper. The next layer is a tissue layer 272 that helps to absorb the liquids from the dog's urination. The layer 274 is the super absorbent polymer layer that helps absorb both the liquid urination and anything off the solid deposit from the dog's defecation. Next comes another tissue layer 276 for further liquid absorption, and finally the bottom layer 278 is made of a plastic or similar non-absorbent material or material impervious to liquids to prevent any other urine or solids to leak through the rolled up soiled roll of pads ready for removal and deposit before a fresh supply of roll of pads is installed in the supply and connected to the rod assembly in the take-up housing.

What is claimed is:

1. A method for pet waste removal, comprising:
installing a pad on a surface of a platform;
receiving pet waste on the pad, wherein a portion of the pad receiving the pet waste defines a soiled portion of the pad;
capturing one or more images of the pad, wherein the one or more captured images are compared to a reference image; and
based on the one or more captured images being compared to the reference image, detecting a type of pet waste on the pad or an amount of pet waste on the soiled portion of the pad.

2. The method of claim 1, wherein the type of pet waste is detected, and wherein the type of pet waste comprises a solid waste, a liquid waste, or a combination thereof.

3. The method of claim 2, further comprising, after detecting the type of pet waste, differentiating the type of pet waste between solid waste and liquid waste.

4. The method of claim 1, further comprising advancing the pad across the platform until at least one of the one or more captured images matches the reference image.

5. The method of claim 4, wherein advancing the pad includes receiving a command from a remote control, further wherein the remote control is in communication with the platform via an internet connection.

6. The method of claim 5, further comprising generating a notification for display on the remote device indicating when to dispose of the pad or when to position a fresh pad on the platform.

7. The method of claim 5, further comprising generating a notification for display on the remote device warning an end user to reposition the pad to track properly along the platform.

8. The method of claim 4, further comprising checking for a presence of an animal on the platform with an animal sensor, further wherein checking for the presence of an animal comprises comparing a captured image with the reference image, and further wherein advancing the pad is delayed if the presence of the animal is detected by the animal sensor.

9. The method of claim 4, wherein advancing the pad is performed automatically with a control and drive module, wherein the control and drive module is coupled to the platform and capable of advancing the pad across the platform.

10. The method of claim 5, wherein the remote control is a Bluetooth device, a home automation system, a mobile user terminal, or an Internet connected device.

11. The method of claim 1, wherein the pad comprises a plurality of markings along a length of the pad, and wherein the method further comprises, after capturing one or more images of the roll of pads disposed on the flat surface, reading at least one of the plurality of markings with a mark sensor to determine a position of the soiled portion of the pad.

12. The method of claim 1, further comprising, after capturing the one or more images, determining a cleanliness of the pad.

13. A method for pet waste removal, comprising:
installing a pad on a surface of a platform;
receiving pet waste on the pad, wherein a portion of the pad receiving the pet waste defines a soiled portion of the pad;
capturing one or more images of the pad, wherein the one or more captured images are compared to a reference image; and
based on the one or more captured images being compared to the reference image, detecting a type of pet waste on the pad, wherein the type of pet waste comprises a solid waste, a liquid waste, or a combination thereof; and
based on the one or more captured images being compared to the reference image, detecting an amount of pet waste on the soiled portion of the pad.

14. The method of claim 13, further comprising differentiating the type of pet waste.

15. The method of claim 14, further comprising, after differentiating the type of pet waste, advancing the pad until at least one of the one or more captured images matches the reference image.

16. The method of claim 14, further comprising, after differentiating the pet waste, determining a cleanliness of the pad.

17. The method of claim 15, wherein advancing the pad includes receiving a command from a remote control, further wherein the remote control is in communication with the platform via an internet connection.

18. The method of claim 15, wherein the pad comprises a plurality of markings along a length of the pad, and wherein the method further comprises, after capturing one or more images of the pad, reading at least one of the plurality of markings with a mark sensor to determine a position of the soiled portion of the pad.

19. The method of claim 15, further comprising checking for a presence of an animal on the platform with an animal sensor, further wherein checking for the presence of an animal comprises comparing a captured image with the reference image.

20. The method of claim 18, wherein advancing the pad is delayed if the presence of the animal is detected by the animal sensor.
